(19) United States
(12) Patent Application Publication
(10) Pub. No.: US 2025/0383437 A1
(43) Pub. Date: Dec. 18, 2025

(54) METHOD FOR DETECTING A LIVING BEING, EVALUATION UNIT AND VEHICLE

(71) Applicant: HELLA GMBH & CO. KGAA, Lippstadt (DE)

(72) Inventors: Orlando Ciricosta, Berlin (DE); Etienne Costa-Patry, Berlin (DE); Esakki Ponraj Esakkimuthu, Berlin (DE)

(21) Appl. No.: 19/316,190

(22) Filed: Sep. 2, 2025

Related U.S. Application Data
(63) Continuation of application No. PCT/EP2024/055469, filed on Mar. 1, 2024.

(30) Foreign Application Priority Data
Mar. 6, 2023 (DE) 102023105451.1

(51) Int. Cl. G01S 13/56; G01S 13/02

(52) U.S. Cl. CPC G01S 13/56; G01S 13/0209

(57) ABSTRACT

The invention relates to a method for detecting a living being, an evaluation for this purpose, and a vehicle having such an evaluation unit. To this end, at least one sensor records measurement values in a plurality of measurement cycles, said measurement values being able to be arranged successively in a vector, wherein the vector is provided to an evaluation unit. The vector comprises the recorded measurement values chronologically successively. At a definable time, a measurement point is determined in each case from the measurement values. The measurement points form a fluctuating function. The fluctuating function is averaged and an average value is provided. Advantageously, the respective measurement point is selected such that the respective measurement points produce a periodic, i.e. fluctuating, function with an amplitude and a number of average value crossings. Based on the amplitude and the number, there is a detection of a living being.

### CROSS-REFERENCE TO RELATED APPLICATIONS

The present application is a continuation of PCT/EP2024/055469, filed Mar. 1, 2024, which claims the benefit of German Patent Application No. 10-2023-105-451.1, filed Mar. 6, 2023, the disclosures of which are incorporated by reference in their entirety.

### FIELD OF THE INVENTION

The invention relates to a method for detecting a living being and an evaluation unit for this purpose. The invention also relates to an application of the method for detecting a small child in a vehicle as well as a vehicle.

### BACKGROUND OF THE INVENTION

In modern vehicles, it is advantageous today to be able to detect whether a small child has been left in the car, as this can pose a considerable danger to the small child, especially in regions with a warm climate. Methods for detecting small children are known in principle, for example with the help of optical cameras. It would be advantageous if such a camera were no longer necessary for monitoring the interior and could be replaced by other sensors such as radar sensors or ultra-wideband (UWB) sensors, whereby it would be advantageous to use sensors that are already present in the vehicle. The disadvantage of the use of such sensors is the complex and memory-intensive use when evaluating the signals provided by the sensors. Therefore, the purpose of the invention is to simplify the evaluation of sensors, in particular to enable this with less memory.

### SUMMARY OF THE INVENTION

The foregoing problem is solved by a method according to the current embodiments, an evaluation unit, and a vehicle having such an evaluation unit.

The method is used to detect a living being in an area, in particular to detect an adult or a small child in an area. In the method, measured values from at least one sensor are provided to an evaluation unit, wherein the evaluation unit performs at least the following steps: formation of a one-dimensional vector, wherein the vector comprises chronologically ordered measured values of at least one sensor; formation of a fluctuating function (F); formation of an average value of the fluctuating function (F), in particular by averaging measured values (M) that are recurring over time; determination of the number of measured values which essentially correspond to the respective average value or; determination of the number of average value crossings of a difference between the measured values and the respective average value of the measured values; wherein the number of average value crossings and/or the number of measured values that essentially correspond to the respective average value is used to detect the type of the living being.

The invention is based on the knowledge that the signal provided by the respective sensor depicts a movement in the area monitored by the sensor. The signal, therefore, varies slightly from measurement cycle to measurement cycle. A fluctuating, in particular a periodic, movement such as the respiration of a living being in the area leads to a more or less periodic change of the signal from measurement cycle to measurement cycle.

Advantageously, detection of a living being is understood here as both the detection of a living being and the classification of the type of living being. Advantageous is a classification of a living being as a small child, an adult or a pet.

An area can be understood as the interior of a vehicle. In particular, the area can be a rear seat bench of a vehicle. Advantageously, the area is defined by the position and/or the orientation of the at least one sensor. Advantageously, the area is a passenger compartment of a vehicle.

At a predeterminable point in time within the respective measurement cycle, the measured values may fluctuate at the predeterminable point in time.

A fluctuating function is, in particular, a function consisting of a number of measured values that are ordered chronologically. The function has an average value, whereby the measured values “fluctuate” around the average value (the total of the measured values). The function is advantageously a mapping of the respective measured value and designed as a function of time. Alternately, function values (measured values) are, in a sub-area of the function, greater than the average value of the function, and, in a subsequent sub-area of the function, smaller than the average value of the function.

The average value crossings, i.e. the areas in which at least one measured value essentially corresponds to the average value, may or may not be arranged equidistantly in time. If the average value crossings are arranged equidistantly, the function fluctuates periodically around the average value.

The vector advantageously comprises the measured values of the individual measurement cycles arranged one after the other. For example, a measurement cycle comprises 100 measured values, which have been recorded one after the other every millisecond.

Insofar as the measured values are provided by the respective sensor as complex values, each comprising an amount and a phase, the amounts can be arranged in a first section of the vector and the phases can be arranged in a second section of the vector.

Alternatively, the respective amounts of the respective measured value and the respective phase can be arranged alternately in the vector.

Advantageously, the measured values are recorded as a function in a recurrent manner. For example, 100 measured values are recorded within 100 microseconds and the recording is repeated 100 times.

To enable a simplified evaluation, the every nth measured value is stored in a reduced vector as an example. For example, every 30th measured value each can form an entry in a reduced vector. This means that a vector of 10,000 entries is “reduced” to a vector with 100 entries.

Such a reduced vector can be the basis for the fluctuating function.

From the fluctuating function, the number of average value crossings of the function is determined advantageously. One possibility is that those measured values that correspond to the average value correspond to an average value crossing.

Alternatively or additionally, the number of average value crossings can be determined by how many neighboring measured values have once a lower value and once a higher value than the average value.

Alternatively or additionally, the number of average value crossings can also be the number of measured values that at least essentially correspond to the average value.

The number of average value crossings indicates how often the fluctuating function changes direction. If the living being moves quickly or has a higher breathing rate, it can be concluded that it is a younger living being, e.g. a small child.

Alternatively or additionally, the time interval between the average value crossings of the fluctuating function can also be used to determine the type of living being. The shorter the time interval, the younger the living being. A short interval therefore likewise indicates a small child, while a long interval is more likely to indicate an adult.

In addition, a low amplitude of the respective fluctuating function can also indicate a smaller or younger living being.

It is advantageous to detect the respiratory movement of the living being. Respiration (respiratory amplitude, respiratory frequency) is advantageously reflected in the form of the fluctuating function.

The fluctuating function can be interpreted as a representation of the fluctuating movement, in particular periodic movement, of a living being.

If a fluctuating function is present, an object can be concluded that moves in a fluctuating manner, e.g. through respiration.

Based on the number of average value crossings, the period of the movement can also be concluded. For example, the respiratory or heart rate of a small child is higher than the respiratory or heart rate of an adult. Thus, by determining the average value crossings (per time unit), it is possible to distinguish whether the living being is an adult or a small child.

Advantageously, the vector, the reduced vector and/or the number of average value crossings can be provided to a further evaluation algorithm, in particular a neural network.

With the invention described above, an improved detection of a living being is possible.

In an advantageous embodiment of the invention, an amplitude of the fluctuating function is determined between the respective average value crossings, the amplitude being used to determine the type of living being (adult, pet or small child). The amplitude can be defined as the largest difference between the respective measured value and the average value.

Advantageously, the amplitude of the fluctuating function is determined by determining the difference between the respective function value of the fluctuating function and the average value at half the interval between two average value crossings or in the middle between two values that essentially correspond to the average value.

The amplitude of the fluctuating function is advantageously a measure of a manifestation of the movement of a living being, in particular the amplitude of the respective movement, e.g. respiration as an increase in the diameter of the thorax. For example, the movement of the respiration of a small child is not as pronounced as that of an adult. Therefore, it is to be assumed advantageously, if the amplitude of the fluctuating function is high, that an adult is present in the area.

By taking into account the amplitude of the fluctuating function, an improved detection of a living being and in particular the determination of whether it is an adult or a small child can be made with a higher probability than if only the interval or the number of average value crossings were considered.

In a further advantageous embodiment of the invention, the fluctuating function can be stored as a reduced vector. The reduced vector can, for example, be stored in the memory of an evaluation unit.

Advantageously, the reduced vector can be made available to a neural network, wherein the neural network, through the including of the reduced vector, can be smaller than a neural network that can “include” the (entire) vector.

Advantageously, the fluctuating function comprises fewer measured values than the vector from which the fluctuating function is determined. The reduced vector can therefore be stored in a smaller memory area than the vector.

In a further advantageous embodiment of the invention, a decision on the type of living being is made on the basis of the respective number and/or the amplitude, wherein the living being is determined to be a small child if the number of the average value crossings is greater than a predeterminable number, and if the number is less than the predeterminable number, the living being is determined to be an adult

Determining the type of the living being on the basis of the number of average value crossings and the respective amplitude is advantageous for increasing the certainty in determining the type of the living being.

In a further advantageous embodiment of the invention, the respective measured value comprises a respective amount and a respective phase, wherein the respective amounts of the measured value are arranged in a first section of the vector and the respective phases are arranged in a second section of the vector.

Some sensors provide complex measured values, whereby the respective measured value comprises an amount and a phase. The amounts and/or phases can be evaluated together or separately. Advantageously, the vector comprises a first section with amounts and a subsequent section with phases. V=(B1, . . . , BN, φ1, . . . , φN) wherein B is the respective amount and φ is the respective phase of the measured value.

The vector is also advantageously divided accordingly for the reduced vector.

The procedure is advantageously the same for both the phases and the amounts of the measured values. Advantageously, the method steps described here are performed for the amounts of the respective measured values and for the respective

The separate evaluation of amounts and phases enables a particularly high level of accuracy to be achieved in the detection of living beings.

In a further advantageous embodiment of the invention, a living being is detected in a first step with the aid of the amounts of the vector and/or the reduced vector, and in a second step the living being is detected with the aid of the phases.

The separate evaluation of amounts and phases enables a particularly high level of accuracy to be achieved in the detection of living beings.

In a further advantageous embodiment of the invention, the living being is detected as a small child if: a predeterminable number of amplitudes remains below a predeterminable amplitude; and/or the number of averaging value crossings is higher than a predeterminable number (of average value crossings).

The predeterminable number of amplitudes and the predeterminable number of average value crossings are advantageously determined in an experimental manner.

The use of two experimentally determinable variables can ensure a particularly accurate detection of a small child.

In a further advantageous embodiment of the invention, the vector and the fluctuating function are provided to a neural network, wherein the neural network detects the living being based on the fluctuating function and optionally based on the vector and makes a decision whether the living being is a small child, an adult or a pet.

Advantageously, only the fluctuating function or the reduced vector is provided to the neural network, so that the neural network only needs to have a small size and complexity. Thus, the necessary memory in the evaluation unit can be omitted.

The evaluation unit is advantageously designed as a software module. The evaluation unit is advantageously integrated into a control unit for a vehicle.

The method is advantageously designed as an executable computer program product and can advantageously be executed on a computer unit.

The evaluation unit has at least one interface for at least one sensor. The interface can be designed as a software interface. Furthermore, the evaluation unit has a processing unit, wherein the processing unit is designed and intended for performing the method described here. Optionally, the evaluation unit comprises a neural network, wherein the neural network is designed for evaluating the fluctuating function, wherein the neural network is provided for deciding whether a living being is detected and/or for deciding whether the living being is a small child, an adult or a pet.

In a further advantageous embodiment of the invention, the at least one sensor is designed as an ultra-wideband (UWB) sensor.

The vehicle comprises an evaluation unit as described above and at least one sensor for monitoring the area. The area is advantageously the interior of a passenger compartment or a trunk of the vehicle.

Instead of a neural network, another adaptive algorithm can also support the detection and classification of the living being.

### BRIEF DESCRIPTION OF THE DRAWINGS

Below, the invention is explained in more detail with the aid of figures. The embodiments shown in the figures are merely exemplary and cannot be used for the restriction of the invention. In the figures:

FIG. 1 is a vehicle with an example of an evaluation unit;

FIG. 2 is an example of a process diagram;

FIG. 3 is a further example of a process diagram; and

FIG. 4 is an example of a fluctuating function.

### DETAILED DESCRIPTION OF THE CURRENT EMBODIMENT

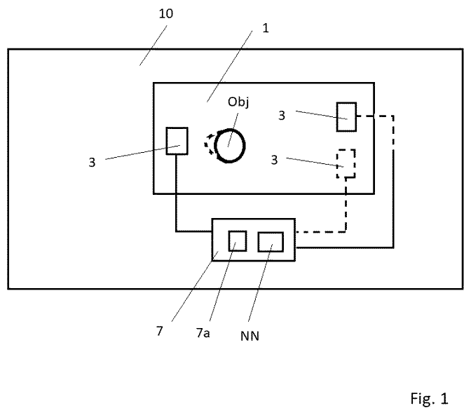

FIG. 1 shows a vehicle 10 with an example of an evaluation unit 7. The vehicle 10 comprises an area 1. The area 1 can be the passenger compartment or the trunk of the vehicle 10. Sensors 3 are used for the monitoring of area 1. For the invention, only one sensor 3 is required. Therefore, the other two sensors 3 are shown as dashed lines. The respective sensor 3 is advantageously designed as an ultra-wideband sensor. The respective sensor 3 provides measured values M1, . . . , MN at respective points in time t, advantageously one measured value M1, . . . , MN at each of the N points in time.

In area 1, a living being Obj is shown. The sensors 3 are used to detect the living being Obj in the area 1. A movement, for example respiration, is characteristic for a living being Obj. This movement is represented by the dashed curve on the living being Obj. The sensors 3 are intended and designed to provide measured values M1, . . . , MN to the evaluation unit 7. The evaluation unit 7 comprises a processing unit 7a, and optionally a neural network. The evaluation unit 7 can, when a living being Obj, in particular a small child KK (without an adult Erw being present at the same time) is detected, provide a signal to a signal transmitter 9. The signal transmitter 9 is used to emit a warning signal if a small child KK has been left behind in the area 1 of the vehicle 10. The signal transmitter 9 can also be equipped with a communication unit to provide a warning signal for a cell phone.

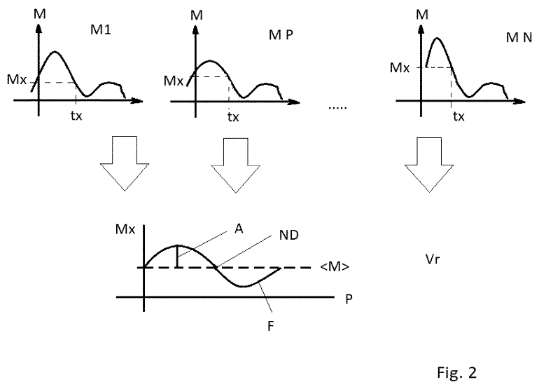

FIG. 2 shows an example of a process flowchart. Measured values M as a function of time t are shown above. The measured values M for three measurement cycles M1, MP and MN are shown. The measurement points Mx are highlighted as M(tx) at predeterminable points in time tx. The measured values for several measurement cycles P can be stored in a vector V=(M1(t1), . . . , M1(tN), . . . , MP(t1), . . . ,MP(tN), . . . , MN(t1), . . . (MN(tN)).

The measurement points Mx can also be storable in a reduced vector Vr=(Mx(P=1), . . . , Mx(P=N)) of the respective measurement cycle P. Here, P goes from P=1 to P=N.

The measurement points Mx form, in chronological order, the fluctuating function F. The fluctuating function F is a function of the respective measurement point Mx of the respective measurement cycle P. The fluctuating function F has an average value <Mx>, wherein measurement points Mx fluctuate back and forth around the average value <Mx>. The fluctuating function F is illustrated in the figure below.

The measurement points that essentially correspond to the center point <Mx> are referred to as average value crossings ND. The fluctuating function exhibits a minimum or maximum between the average value crossings ND. The difference between the respective minimum/maximum and the average value <Mx> is referred to as the amplitude. Depending on the deviation of the measured values M from measurement cycle P at the respective time tx, the function fluctuates more or less strongly. If there is a large deviation in the measured values from measurement cycle P to measurement cycle P, the number #ND of average value crossings ND of the fluctuating function increases. In addition, the distance d between the respective average value crossings ND decreases as the number of #ND increases.

Any noise of the measured values can be advantageously eliminated by averaging.

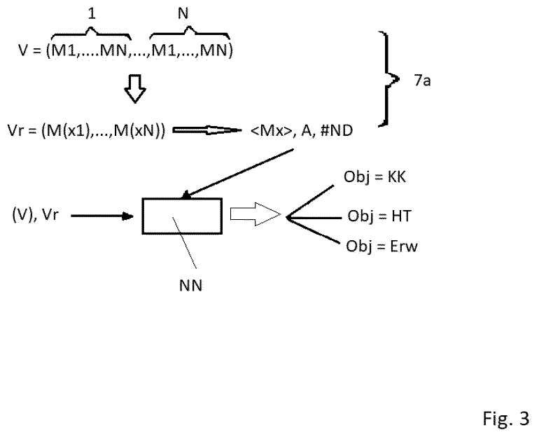

FIG. 3 shows a further example of a process flowchart. In the upper part of the figure, the steps of the processing unit 7a are shown. The conversion of the vector V into the reduced vector is shown, wherein the average value, the number #ND of average value crossings ND and the respective amplitude A are provided. The fluctuating function can be provided as a reduced vector Vr.

It is shown below that the neural network NN is provided with the vector V (comprising the measured values of the measurement cycles P), the reduced vector V (comprising the fluctuating function F). The neural network is also provided with the average value <Mx>, the respective amplitude A and the number #ND of average value crossings ND.

With the help of the neural network, the recognized living being Obj can be identified as a small child KK, a pet HT or an adult Erw.

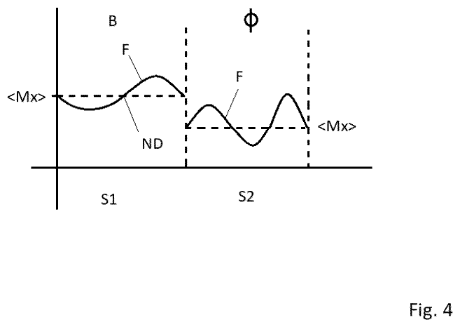

FIG. 4 shows an example of a fluctuating function F. In this example, the measured values M, which have been provided by the respective sensor 3, are provided in complex form (as complex numbers). The fluctuating function F can have a first section S1 and a second section S2. The first section S1 comprises the amounts B of the respective measurement points Mx. The second section S2 comprises the phases φ of the respective measurement points Mx (each in chronological order).

As shown here, the fluctuating function F is evaluated once using the phases φ and once using the amounts B. In other words, once using the first section S1 of the (reduced) vector and once using the second section S2 of the (reduced) vector.

It can be seen that the fluctuating function F for the amounts B and the phases φ can have a different progression.

Such a fluctuating function F can advantageously be determined by a vector V, wherein the vector V has a section with amounts B (of the respective measured value M) and a section with phases φ (of the respective measured value M)

Instead of the fluctuating function F, the respective measured values M can also be shown accordingly.

### LIST OF REFERENCE SIGNS

1 area
3 sensor (in particular, a UWB sensor)
Obj living beings
7 evaluation unit
7a processing unit
10 vehicle
NN neural network
V vector
M1, . . . , MN measured values (provided by the sensor)
F fluctuating function
Mx measurement point
ND average value crossing
A amplitude (from F)
T time
Tx point in time
Vr reduced vector
D interval (between every two average value crossings)
S1, S2 first, second section
<Mx> average value (of the measurement points) or the fluctuating function
B amount (of the measurement point or the measured value)
Φ phase
1, . . . m no. of the measurement cycle
KK small child
Erw adult
HT pet
P measurement cycle
#ND number (of average value crossings)

In summary, the invention relates to a method for detecting a living being Obj, an evaluation unit 7 for this purpose and a vehicle 10 with such an evaluation unit 7. For this purpose, at least one sensor 3 records measured values M1, . . . , MN (P=1, . . . . N) in several measurement cycles P, which can be arranged consecutively in a vector V, wherein the vector V is provided to an evaluation unit 7. The vector V comprises the recorded measured values M in chronological order. At a definable time tx, a measurement point Mx is determined from the measured values M. The measurement points form a fluctuating function F. The fluctuating function is averaged and a average value <Mx> is provided. In other words, an average value <Mx> of the respective nth measured values Mx is calculated.

The respective measurement point Mx is advantageously selected in such a way that the respective measurement points result in a more or less periodic, i.e. fluctuating function F with an amplitude A and a number #ND of average value crossings ND. The amplitude A and the number #ND are used to recognize a living being, in particular whether the living being Obj is an adult Erw, a pet HT or a small child KK.

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for detecting a living being in vehicle, the method comprising:
receiving, at an evaluation unit, measured values from at least one sensor during a measurement cycle;
forming a vector, wherein the vector comprises chronologically ordered measured values of the at least one sensor;
forming a fluctuating function from measurement points, wherein each of the measurement points is a measured value at a predetermined time;
forming an average value of the fluctuating function by averaging the measurement points;
determining the number of the measurement points corresponding to the average value or determining the number of average value crossings of a difference of the measurement points and the average value of the fluctuating function;
determining, using the number of the measurement points or the number of average value crossings, the type of the living being in the vehicle.

2. The method according to claim 1, wherein an amplitude of the fluctuating function is determined between the average value crossings, and wherein the amplitude serves to determine the type of the living being in the vehicle.

3. The method according to claim 1, wherein the fluctuating function is stored in a reduced vector.

4. The method according to claim 1, wherein:
a decision on the type of the living being is based on the number of average value crossings; and
the living being is determined to be a child if the number of average value crossings is greater than a predetermined number;
the living being is determined to be an adult if the number of average value crossings is greater tan the predetermined number.

5. The method according to claim 1, wherein each measured value comprises an amount and a phase, wherein the amount of the measured value is arranged in a first section of the vector and wherein the phase of the measured value is arranged in a second section of the vector.

6. The method according to claim 5, wherein the living object is initially detected with the aid of the amount of the measured value and with the aid of the phase of the measured value.

7. The method according to claim 2, wherein the living being is detected as a small child if:
a predetermined number of amplitudes remains below a predetermined amplitude; and
the number of average value crossings is higher than a predetermined number.

8. The method according to claim 1, wherein the vector of the fluctuating function is provided to a neural network, wherein the neural network detects the living being based on the fluctuating function and the vector and makes a decision whether the living being is a child, a pet, or an adult.

9. An evaluation unit comprising:
a sensor interface; and
a processing unit configured to carry out the method of claim 1.

10. The evaluation unit according to claim 9, wherein the at least one sensor is an ultra-wideband sensor.

11. A vehicle comprising:
the evaluation unit of claim 9; and
at least one sensor for monitoring the vehicle interior.
